(19) United States
(12) Patent Application Publication
(10) Pub. No.: US 2025/0375973 A1
(43) Pub. Date: Dec. 11, 2025

(54) SHEET DISCHARGE APPARATUS AND IMAGE FORMING SYSTEM

(71) Applicant: KYOCERA Document Solutions Inc., Osaka (JP)

(72) Inventors: Yasunori UENO, Osaka (JP); Terumitsu NOSO, Osaka (JP); Yusuke TAKANO, Osaka (JP)

(73) Assignee: KYOCERA Document Solutions Inc., Osaka (JP)

(21) Appl. No.: 19/216,255

(22) Filed: May 22, 2025

(30) Foreign Application Priority Data
Jun. 5, 2024 (JP) 2024-091407

(51) Int. Cl. B41J 13/10; B41J 3/44; B41J 13/00

(52) U.S. Cl. CPC B41J 13/106; B41J 3/44; B41J 13/0036

(57) ABSTRACT

A sheet discharge apparatus includes a discharge tray to which a sheet is discharged and a plurality of pressing portions that are arrayed at an interval from each other along the width direction orthogonal to the discharge direction of the sheet and that each press the sheet on the discharge tray from above. When the sheet on the discharge tray is pressed, regardless of the position and size of the sheet on the discharge tray along the width direction, one of the plurality of pressing portions is arranged at a position opposite, along the top-bottom direction, an end part of the sheet on the discharge tray along the width direction.

### INCORPORATION BY REFERENCE

This application is based on and claims the benefit of priority from Japanese Patent Application No. 2024-091407 filed on Jun. 5, 2024, the contents of which are hereby incorporated by reference.

### BACKGROUND

The present disclosure relates to a sheet discharge apparatus and an image forming system.

Conventional sheet discharge apparatuses include a discharge tray and they discharge a sheet to the discharge tray. For example, the sheet discharge apparatus can be a post-processing apparatus. The post-processing apparatus discharges a sheet to the discharge tray after performing a stapling process or the like on the sheet.

Conventional sheet discharge apparatuses also include a pressing member. The pressing member presses the sheet on the discharge tray from above.

### SUMMARY

According to a first aspect of the present disclosure, a sheet discharge apparatus includes a discharge tray and a plurality of pressing portions. To the discharge tray, a sheet is discharged. The plurality of pressing portions are disposed at an interval from each other along the width direction orthogonal to the discharge direction of the sheet and they each press the sheet on the discharge tray from above. When the sheet on the discharge tray is pressed, regardless of the position and size of the sheet on the discharge tray along the width direction, one of the plurality of pressing portions is arranged at a position opposite, along the top-bottom direction, an end part of the sheet on the discharge tray along the width direction.

According to a second aspect of the present disclosure, an image forming system includes the sheet discharge apparatus described above and an image forming apparatus. The image forming apparatus forms an image on the sheet. The sheet discharge apparatus discharges the sheet conveyed to it from the image forming apparatus to the discharge tray.

### BRIEF DESCRIPTION OF THE DRAWINGS

FIG. 1 is a perspective view of a post-processing apparatus according to an embodiment.

FIG. 2 is a schematic diagram showing the internal structure of the post-processing apparatus according to the embodiment.

FIG. 3 is a block diagram of the post-processing apparatus according to the embodiment.

FIG. 4 is a diagram in illustration of a retraction process performed in the post-processing apparatus according to the embodiment.

FIG. 5 is a perspective view of a sheet pressing member and a discharge tray in the post-processing apparatus according to the embodiment (showing a retracted state).

FIG. 6 is a perspective view of the sheet pressing member and the discharge tray in the post-processing apparatus according to the embodiment (showing a pressing state).

FIG. 7 is a schematic diagram showing the sheet pressing member and its vicinity in the post-processing apparatus according to the embodiment (showing the retracted state).

FIG. 8 is a schematic diagram showing the sheet pressing member and its vicinity in the post-processing apparatus according to the embodiment (showing the pressing state).

FIG. 9 is a diagram showing a positional relationship of a sheet discharged to the discharge tray with pressing portions in the post-processing apparatus according to the embodiment (showing a state where the sheet is shifted in one direction along the width direction).

FIG. 10 is a diagram showing a positional relationship of the sheet discharged to the discharge tray with the pressing portions in the post-processing apparatus according to the embodiment (showing a state where the sheet is shifted in the other direction along the width direction).

FIG. 11 is a diagram in illustration of an inconvenience that may occur with first pressing portions not enlarged along the width direction in the post-processing apparatus according to the embodiment.

### DETAILED DESCRIPTION

Now, a sheet discharge apparatus according to the present disclosure will be described taking as an example a post-processing apparatus.

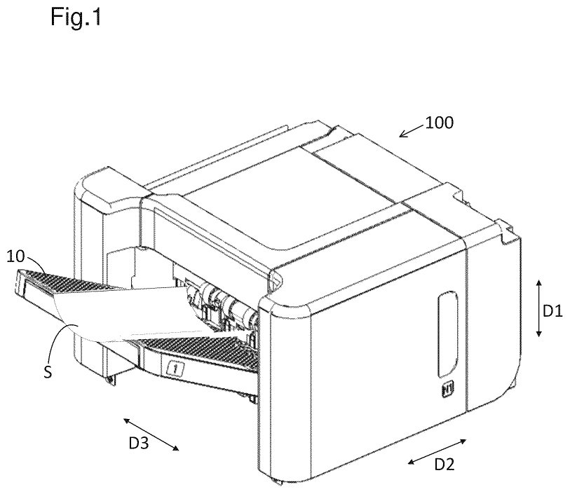

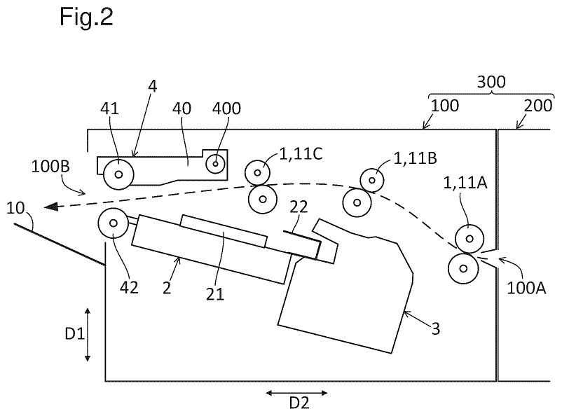

Configuration of Post-processing Apparatus: A post-processing apparatus 100 (corresponding to a “sheet discharge apparatus”) according to an embodiment has an exterior appearance as shown in FIG. 1. As shown in FIG. 2, the post-processing apparatus 100 can be coupled with an image forming apparatus 200. The image forming apparatus 200 performs a printing job in which it forms an image on a sheet S. For example, the image forming apparatus 200 is an inkjet recording apparatus. That is, the image forming apparatus 200 ejects ink onto the sheet S to form an image with the ink on the sheet S. The post-processing apparatus 100 is coupled with the image forming apparatus 200 to constitute an image forming system 300 together with the image forming apparatus 200.

The top-bottom direction of the post-processing apparatus 100 is the direction indicated by arrow D1. The left-right direction of the post-processing apparatus 100 is the direction indicated by arrow D2. The front-rear direction of the post-processing apparatus 100 is the direction perpendicular to the plane of FIG. 2, and thus is the direction indicated by arrow D3 in FIG. 1. FIG. 2 shows the inside of the post-processing apparatus 100 as seen from the front-rear direction. In the following description, the right side of FIG. 2 is defined as the right side of the post-processing apparatus 100 and the left side of FIG. 2 is defined as the left side of the post-processing apparatus 100.

The post-processing apparatus 100 has a conveying port 100A in its right side face and a discharging port 100B in its left side face. The post-processing apparatus 100 conveys into it the printed sheet S (i.e., the sheet S with the image formed on it) from the image forming apparatus 200 via the conveying port 100A.

In addition, the post-processing apparatus 100 includes a discharge tray 10. The discharge tray 10 protrudes leftward from the left side face of the post-processing apparatus 100. The post-processing apparatus 100 conveys the sheet S conveyed into it via the conveying port 100A to the discharge tray 10 to discharge it via the discharging port 100B. In FIG. 2, the sheet conveyance passage is indicated by an arrowed broken line. After being conveyed into the post-processing apparatus 100, the sheet S is conveyed from the right side to the left side of the post-processing apparatus 100.

The post-processing apparatus 100 includes a conveyance portion 1. The conveyance portion 1 includes a plurality of pairs of conveying rollers 11. Three of the pairs of conveying rollers 11 are provided. In the following description, whenever needed, the three pairs of conveying rollers 11 are distinguished with different alphabetical letters appended to their reference signs.

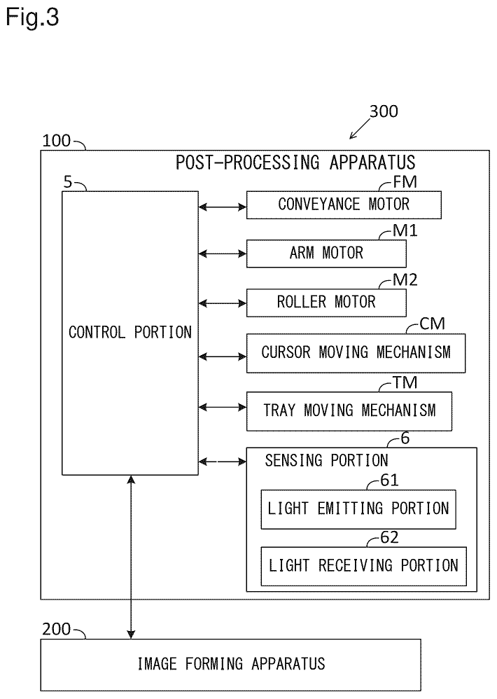

The three pairs of conveying rollers 11 are supported such that each roller is rotatable about an axis extending along the front-rear direction. The three pairs of conveying rollers 11 each include a pair of rollers kept in pressed contact with each other. One rollers in the pairs are coupled with a single conveyance motor FM (see FIG. 3) and rotates with the motive power transmitted from the conveyance motor FM. The other rollers in the pairs rotate by following the rotation of the one rollers with which they are in pressed contact. The three pairs of conveying rollers 11 each nip the sheet S between the pair of rollers and rotate to convey the sheet S.

The pairs of conveying rollers 11A, 11B, and 11C are disposed in this order from upstream to downstream in the sheet conveyance direction. In this configuration, of the three pairs of conveying rollers 11 in the conveyance portion 1, the pair of conveying rollers 11C is the pair of conveying rollers 11 disposed most downstream in the sheet conveyance direction. Note that there is no limitation on the number of pairs of conveying rollers 11 disposed. Any modification can be made on the number of pairs of conveying rollers 11 disposed depending on the length of the sheet conveyance passage. The number of pairs of conveying rollers 11 disposed can be four or more, or two or less.

The post-processing apparatus 100 includes a processing tray 2. The processing tray 2 is disposed at a position where the sheet S having passed through the pair of conveying rollers 11C in the conveyance portion 1 can be stacked. Specifically, the processing tray 2 is inclined obliquely downward from downstream to upstream in the sheet conveyance direction. In addition, a slope-top end part of the processing tray 2 is located downstream of the pair of conveying rollers 11C in the sheet conveyance direction. A slope-bottom end part of the processing tray 2 is located upstream of the pair of conveying rollers 11C in the sheet conveyance direction (i.e., rightward of the pair of conveying rollers 11C), below the pair of conveying rollers 11C along the top-bottom direction. In this configuration, after the trailing edge of the sheet S has passed through the pair of conveying rollers 11C, the sheet S is switched back so as to be stacked on the processing tray 2.

In post-processing, a plurality of sheets S are stacked on the processing tray 2. The post-processing is performed on a bundle of sheets S on the processing tray 2. The details will be described later.

The post-processing apparatus 100 includes a pair of cursors 21. The pair of cursors 21 are fitted to the processing tray 2. The pair of cursors 21 are disposed at an interval from each other along the front-rear direction. The pair of cursors 21 are supported so as to be reciprocatable along the front-rear direction. The pair of cursors 21 can reciprocate on the processing tray 2 along the front-rear direction. The pair of cursors 21 lie on opposite sides of the sheets S on the processing tray 2 along the front-rear direction. This allows the alignment of the plurality of sheets S on the processing tray 2 along the front-rear direction.

The post-processing apparatus 100 includes a reference plate 22. The reference plate 22 is fitted to the processing tray 2. The reference plate 22 is disposed at the slope-bottom side of the processing tray 2. With the sheets S stacked on the processing tray 2, the trailing edges of the sheets S are in contact with the reference plate 22. This allows the alignment of the trailing edges of the plurality of sheets S on the processing tray 2.

The post-processing apparatus 100 includes a stapler 3. The stapler 3 is disposed at the slope-bottom side of the processing tray 2. The stapler 3 performs a stapling process in which it binds the bundle of sheets S on the processing tray 2 with a staple. The stapling process by the stapler 3 is post-processing that can be performed on the post-processing apparatus 100. That is, the stapler 3 corresponds to a “post-processing portion.”

The post-processing apparatus 100 includes a discharge portion 4. The discharge portion 4 is disposed downstream of the conveyance portion 1 in the sheet conveyance direction. The discharge portion 4 performs a discharging process in which it discharges the sheet S (including the bundle of sheets S on the processing tray 2) to the discharge tray 10.

The discharge portion 4 includes an arm 40. The arm 40 is disposed above the sheet conveyance passage. The arm 40 extends along the left-right direction as seen from the front-rear direction. The arm 40 has a rotation shaft 400 in a right end part of it (corresponding to “one end part”). The rotation shaft 400 of the arm 40 extends along the front-rear direction. The arm 40 is pivotable such that, about the rotation shaft 400 in its right end part, its left end part (corresponding to “another end part”) moves up and down. As the rotation shaft 400 rotates, the arm 40 moves its left end part up and down.

The discharge portion 4 includes a driving roller 41. The driving roller 41 is disposed above the sheet conveyance passage. The driving roller 41 is rotatably supported in the left end part of the arm 40. The driving roller 41 is rotatable about an axis extending along the front-rear direction. The driving roller 41, supported in the left end part of the arm 40, can move up and down together with the left end part of the arm 40.

The discharge portion 4 includes a driven roller 42. The driven roller 42 is disposed below the driving roller 41 across the sheet conveyance passage. Specifically, the driven roller 42 is disposed at the slope-top side of the processing tray 2. The driven roller 42 is supported so as to be rotatable about an axis extending along the front-rear direction. The driven roller 42 can be rotatably supported on the slope-top end part of the processing tray 2.

The driving roller 41 and the driven roller 42 are disposed at positions where they can make pressed contact with each other. Downward movement of the driving roller 41 brings the driving roller 41 and the driven roller 42 into pressed contact with each other. From that state, as the driving roller 41 moves upward, the driving roller 41 moves apart from the driven roller 42.

The discharge portion 4 includes an arm motor M1 (see FIG. 3). The arm motor M1 is coupled with the rotation shaft 400 of the arm 40 to rotate the rotation shaft 400. That is, the arm motor M1 transmits motive power to the arm 40 so as to move the left end part of the arm 40 up and down.

The discharge portion 4 includes a roller motor M2 (see FIG. 3). The roller motor M2 is coupled with the driving roller 41 (its rotation shaft). The driving roller 41 rotates with motive power transmitted from the roller motor M2. The driven roller 42 rotates by following the rotation of the driving roller 41.

As shown in FIG. 3, the post-processing apparatus 100 also includes a control portion 5. The control portion 5 includes processing circuits such as a CPU and an ASIC. The control portion 5 includes storage devices such as a ROM and a RAM. For example, the image forming apparatus 200 includes an operation panel (not shown) that receives settings, instructions, and the like from a user. The control portion 5 communicates with the image forming apparatus 200 to recognize the settings, instructions, and the like that the operation panel has received. This allows the control portion 5 to recognize the size of the sheet S used in a printing job (i.e., the size of the sheet S conveyed into the post-processing apparatus 100 from the image forming apparatus 200). The control portion 5 also recognizes whether to perform a sorting process, which will be described later.

The control portion 5 controls the conveyance of the sheet S by the conveyance portion 1. That is, the control portion 5 controls the conveyance motor FM.

For example, the sheet conveyance passage can be provided with a conveyance sensor (not shown) that changes its output according to the presence/absence of the sheet S. Usable as the conveyance sensor is an optical sensor having a light emitting portion and a light receiving portion. The conveyance sensor has its sensing position at a predetermined position on the sheet conveyance passage. With this configuration, based on the timing with which the leading edge of the sheet S arrivals at, or its trailing-edge leaves, the sensing position by the conveyance sensor, the control portion 5 can check whether the trailing edge of the sheets S has passed through the pair of conveying rollers 11C in the conveyance portion 1.

The control portion 5 controls post-processing for the sheet S on the processing tray 2. That is, the control portion 5 controls the stapling process by the stapler 3. The control portion 5 controls a stapler moving mechanism (not shown; a mechanism including a motor and the like) that moves the stapler 3 along the front-rear direction, so that it appropriately moves the stapler 3 along the front-rear direction to change the stapling position. The control portion 5 also judges when to drive a staple into the bundle of sheets S on the processing tray 2.

The control portion 5 controls the position of the pair of cursors 21 along the front-rear direction. Specifically, the post-processing apparatus 100 includes a cursor moving mechanism CM. The cursor moving mechanism CM is a mechanism including a motor and the like and is coupled with the pair of cursors 21. The control portion 5 controls the cursor moving mechanism CM to appropriately move the pair of cursors 21 along the front-rear direction.

The control portion 5 moves the pair of cursors 21 along the front-rear direction such that the sheet S on the processing tray 2 lies between the pair of cursors 21 along the front-rear direction. That is, the control portion 5 brings, with respect to the sheets S on the processing tray 2, one of the cursors 21 into contact with their front side and the other of the cursors 21 into contact with their rear side. This allows, if a plurality of sheets S are stacked on the processing tray 2, the alignment of the plurality of sheets S on the processing tray 2 along the front-rear direction.

In addition, as will be described in detail later, in a sorting process, the control portion 5 moves, with the sheet S on the processing tray 2 lying between the pair of cursors 21 along the front-rear direction, the pair of cursors 21 in the same direction along the front-rear direction. That is, in a sorting process, the control portion 5 shifts the sheet S on the processing tray 2 along the front-rear direction.

The control portion 5 controls the discharge portion 4. That is, the control portion 5 not only controls the arm motor M1 but also controls the roller motor M2. The discharge portion 4 controls, in addition to the discharging process of discharging the sheet S to the discharge tray 10, a retracting process of retracting the sheet S onto the processing tray 2 (corresponding to a process of stacking the sheets S onto the processing tray 2).

When the first sheet S in the printing job is conveyed into the post-processing apparatus 100 from the image forming apparatus 200, the control portion 5 makes the discharge portion 4 perform a preparing process. Specifically, the control portion 5 moves the driving roller 41 downward to bring the driving roller 41 and the driven roller 42 into direct pressed contact with each other. The control portion 5 then rotates the driving roller 41 forward. This results in the leading edge of the sheet S being nipped between the driving roller 41 and the driven roller 42, so that the sheet S is conveyed as it is by the driving roller 41 and the driven roller 42.

After that, if the job to be performed is a job involving no post-processing that requires no post-processing, there is no need to retract the sheet S onto the processing tray 2. Thus, in this case, the control portion 5 lets the driving roller 41 and the driven roller 42 continue conveying the first sheet S. Thus the sheet S is discharged to the discharge tray 10. After that, until the completion of the job involving no post-processing, the control portion 5 continues, without moving the driving roller 41 apart from the driven roller 42, the conveyance of the sheet S with the driving roller 41 and the driven roller 42. That is, also the second and subsequent sheets S are, without being retracted onto the processing tray 2, discharged to the discharge tray 10. In some jobs, only one sheet S is processed.

On the other hand, if the job to be performed is a job involving post-processing, the sheet S has to be retracted onto the processing tray 2. Thus, in this case, after the trailing edge of the first sheet S has passed through the pair of conveying rollers 11C in the conveyance portion 1, the control portion 5 makes the discharge portion 4 perform a retracting process, which will now be described in detail. Note that, in the job involving post-processing, a plurality of sheets S are continuously conveyed into the post-processing apparatus 100 from the image forming apparatus 200.

When the job to be performed is a job involving post-processing, after the trailing edge of the first sheet S has passed through the pair of conveying rollers 11C in the conveyance portion 1, before the trailing edge of the first sheet S passes between the driving roller 41 and the driven roller 42, the control portion 5 rotates the driving roller 41 backward. This results in the first sheet S being retracted onto the processing tray 2, so that it is placed on the processing tray 2.

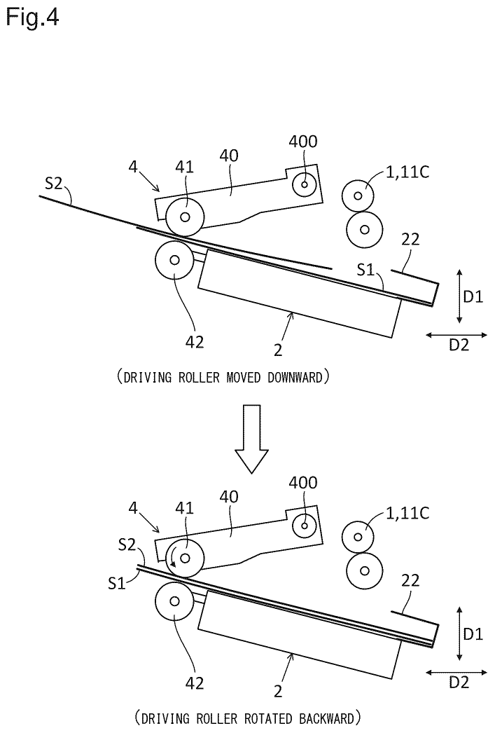

After the first sheet S is placed on the processing tray 2, the control portion 5 moves the driving roller 41 upward to move the driving roller 41 apart from the topmost sheet S (here, the first sheet S) on the processing tray 2. In this state, the conveyance portion 1 conveys the second sheet S. After that, control proceeds as shown in FIG. 4.

Specifically, as shown in FIG. 4, at top, after the trailing edge of the second sheet S has passed through the pair of conveying rollers 11C in the conveyance portion 1, the control portion 5 moves the driving roller 41 downward such that the driving roller 41 is brought, from above, into contact with the sheet S having passed through the pair of conveying rollers 11C. This stops the advancement of the sheet S toward the discharge tray 10.

In addition, as shown in FIG. 4, at bottom, after (or substantially simultaneously with) bringing the driving roller 41 into contact with the second sheet S from above, the control portion 5 rotates the driving roller 41 backward. That is, the control portion 5 rotates the driving roller 41 in the direction (counterclockwise in FIG. 4) opposite to that when discharging the sheet S to the discharge tray 10. Thus, the sheet S is retracted onto the processing tray 2 and the second sheet S is stacked on the first sheet S. In FIG. 4, the first and second sheets S (i.e., the preceding and following sheets S) are distinguished with the numbers “1” and “2” appended to their reference signs respectively.

Then, while not shown, the control portion 5 moves the driving roller 41 upward to move the driving roller 41 apart from the topmost sheet S (here, the second sheet S) on the processing tray 2. In this state, the conveyance portion 1 conveys the third sheet S.

The retraction process on the third and subsequent sheets S is controlled in the same manner as the retraction process on the second sheet S. In this way, the sheets S are retracted successively onto the processing tray 2. That is, on the proceeding sheet S, the following sheet S is stacked. Note that the retraction process on the first sheet S can be controlled in the same manner as the retraction process on the second sheet S. That is, after the trailing edge of the first sheet S passes through the pair of conveying rollers 11C in the conveyance portion 1, the driving roller 41 can be moved downward to be brough into contact with the first sheet S from above and then it can be rotated backward.

The control portion 5 checks whether the number of sheets S stacked on the processing tray 2 has reached a target number. For example, the control portion 5 communicates with a main control portion (not shown) in the image forming apparatus 200 to recognize the target number. For example, the target number is the number of sheets in one copy. When the number of sheets S stacked on the processing tray 2 has reached the target number, the control portion 5 performs post-processing on the plurality of sheets S on the processing tray 2. That is, the control portion 5 performs post-processing on the bundle of sheets S on the processing tray 2.

With the driving roller 41 apart from the topmost sheet S on the processing tray 2, the control portion 5 performs post-processing on the bundle of sheets S on the processing tray 2. When a stapling process is performed as post-processing, the control portion 5 holds the bundle of sheets S on the processing tray 2 with the stapler 3 and drives a staple into the bundle of sheets S. If, after the stapling process as post-processing, a sorting process, which will be described later, is performed, the control portion 5 moves the pair of cursors 21 along the front-rear direction to shift the post-processed bundle of sheets S on the processing tray 2 along the front-rear direction.

Then, the control portion 5 makes the discharge portion 4 perform a discharging process of discharging the post-processed bundle of sheets S on the processing tray 2 to the discharge tray 10. Note that, with the sheets S stacked on the processing tray 2, the leading edge parts of the sheets S on the processing tray 2 lie out of the processing tray 2, on the driven roller 42. That is, even with the sheets S stacked on the processing tray 2, the bundle of sheets S on the processing tray 2 can be nipped between the driving roller 41 and the driven roller 42.

When making the discharge portion 4 perform the discharging process, the control portion 5 moves the driving roller 41 downward to nip the bundle of sheets S on the processing tray 2 between the driving roller 41 and the driven roller 42. In other words, the control portion 5 brings the driving roller 41 into contact with the topmost sheet S on the processing tray 2 from above. In this state, the control portion 5 rotates the driving roller 41 forward. Thus, the bundle of sheets S on the processing tray 2 is discharged to the discharge tray 10 via the discharging port 100B.

In some cases, as post-processing, no stapling process is performed and only a sorting process, which will be described later, is performed. In this case, the bundle of sheets S on the processing tray 2 is shifted along the front-rear direction and the discharging process is performed in a similar manner. In addition, if no stapling process is performed, the sheets S need not be stacked in the form of a bundle on the processing tray 2. Thus, in some cases, every time one sheet S is stacked on the processing tray 2, that sheet S is shifted along the front-rear direction while being discharged to the discharge tray 10.

Here, the post-processing apparatus 100 includes a tray moving mechanism TM (see FIG. 3). The tray moving mechanism TM is a mechanism that reciprocates the discharge tray 10 along the top-bottom direction. Thus, the discharge tray 10 can reciprocate along the top-bottom direction.

The tray moving mechanism TM can be configured with, though not shown, a belt, a pulley around which the belt is wound, a motor that rotates the pulley, and the like. In this configuration, the discharge tray 10 is coupled with the belt in the tray moving mechanism TM. Thus, as the motor in the tray moving mechanism TM is driven, the discharge tray 10 moves along the top-bottom direction.

The post-processing apparatus 100 includes a sensing portion 6. The sensing portion 6 senses the position of the sheet S on the discharge tray 10 along the top-bottom direction. The sensing portion 6 is connected to the control portion 5. Based on the output from the sensing portion 6, the control portion 5 controls the position of the discharge tray 10 along the top-bottom direction.

The sensing portion 6 includes an optical sensor of a transmission type including a light emitting portion 61 and a light receiving portion 62. The light emitting portion 61 and the light receiving portion 62 are disposed so as to face each other along the width direction. The sensing portion 6 has as its sensing region a region between the light emitting portion 61 and the light receiving portion 62 along the width direction (i.e., the optical path of the light emitted from the light emitting portion 61 to the light receiving portion 62).

The light emitting portion 61 emits light to the light receiving portion 62. If the light emitted from the light emitting portion 61 to the light receiving portion 62 is not intercepted, the light receiving portion 62 receives the light emitted from the light emitting portion 61. The sensing portion 6 changes its output depending on whether the light emitted from the light emitting portion 61 to the light receiving portion 62 is intercepted.

The sensing portion 6 has its sensing region above the discharge tray 10. That is, the optical path between the light emitting portion 61 and the light receiving portion 62 along the width direction is disposed above the discharge tray 10. In addition, the light emitting portion 61 and the light receiving portion 62 are disposed, regardless of the position and size of the sheet S on the discharge tray 10 along the width direction, at such positions that they lie across the sheet S on the discharge tray 10 in the width direction.

Based on the output from the sensing portion 6, the control portion 5 checks whether the sensing region of the sensing portion 6 (i.e., the region between the light emitting portion 61 and the light receiving portion 62 along the width direction) is blocked by the sheet S on the discharge tray 10. Then, based on whether the sensing region of the sensing portion 6 is blocked by the sheet S on the discharge tray 10, the control portion 5 controls the position of the discharge tray 10 along the top-bottom direction.

For example, when a printing job is started (i.e., when a sheet S is conveyed into the post-processing apparatus 100 from the image forming apparatus 200), the control portion 5 holds the discharge tray 10 at a predetermined position along the top-bottom direction. In other words, with no sheet S stacked on the discharge tray 10, the control portion 5 holds the discharge tray 10 at the predetermined position along the top-bottom direction. In that state, the control portion 5 makes the discharge portion 4 discharge the sheet S to the discharge tray 10.

After that until the sensing region of the sensing portion 6 is blocked by the sheet S on the discharge tray 10, the control portion 5 does not change the position of the discharge tray 10 along the top-bottom direction. Thus, if sheets S are continuously discharged to the discharge tray 10, the sensing region of the sensing portion 6 is blocked by the sheets S on the discharge tray 10.

When the sensing region of the sensing portion 6 is blocked by the sheet S on the discharge tray 10, the control portion 5 lowers the discharge tray 10 to eliminate the blocking of the sensing region of the sensing portion 6 by the sheet S on the discharge tray 10. In that state, the control portion 5 makes the discharge portion 4 continue discharging the sheet S to the discharge tray 10. After that, every time the sensing region of the sensing portion 6 is blocked by the sheet S on the discharge tray 10, the control portion 5 lowers the discharge tray 10. This prevents the sheet S about to be discharged to the discharge tray 10 from being hampered from being discharged by the sheet S on the discharge tray 10 (i.e., the previously discharged sheet S).

Outline of Sorting Process: The post-processing apparatus 100 can perform a sorting process (shifting process). The sorting process is a process of displacing the sheet S on the discharge tray 10 along the width direction copy by copy. Note that the width direction is a direction orthogonal to the discharge direction of the sheet S discharged from the processing tray 2 to the discharge tray 10 and corresponds to the front-rear direction of the post-processing apparatus 100.

In the sorting process, the sheets S are stacked on the processing tray 2. The pair of cursors 21 move along the width direction with the sheets S on the processing tray 2 between them along the width direction to shift the sheets S on the processing tray 2 along the width direction. The discharge portion 4 discharges the sheets S on the processing tray 2 shifted along the width direction to the discharge tray 10.

The sheets S of the first copy to be discharged first are shifted in one direction along the width direction on the processing tray 2 and are, in that state, discharged to the discharge tray 10. The sheets S of the second and subsequent copies are shifted in the direction opposite to the shift direction of the sheets S of the immediately previous copy (the preceding copy) and are, in that state, discharged to the discharge tray 10. That is, the sheets S of the second copy are shifted in the other direction along the width direction. The sheets S of the third copy are shifted in the one direction along the width direction.

Configuration of Sheet Pressing Member: The post-processing apparatus 100 discharges, to the discharge tray 10, the sheet S conveyed into it from the image forming apparatus 200. Here, if the image forming apparatus 200 is an inkjet recording apparatus, the sheet S with ink on it is conveyed into the post-processing apparatus 100. If the sheet S has ink on it, it is more likely to curl. Thus, the curled sheet S is stacked on the discharge tray 10 (see FIG. 1). If the sheet S curls, end parts of the sheet S along the width direction warp upward. In the following description, any curled end part of the sheet S along the width direction are referred to simply as a warped part.

With the sheet S on the discharge tray 10 curled, the sensing region of the sensing portion 6 (i.e., the region between the light emitting portion 61 and the light receiving portion 62 along the width direction) is blocked by the warped part of the sheet S. This results in the discharge tray 10 being lowered unnecessarily. In other words, it results in too long a distance between the discharge tray 10 and the discharging port 100B along the top-bottom direction. That is, the falling distance of the sheet S from the discharging port 100B to the discharge tray 10 is too long. A long falling distance of the sheet S from the discharging port 100B to the discharge tray 10 may inconveniently result in poor alignment of the sheet S on the discharge tray 10. Also inconveniently, the sheet S may suffer major damage.

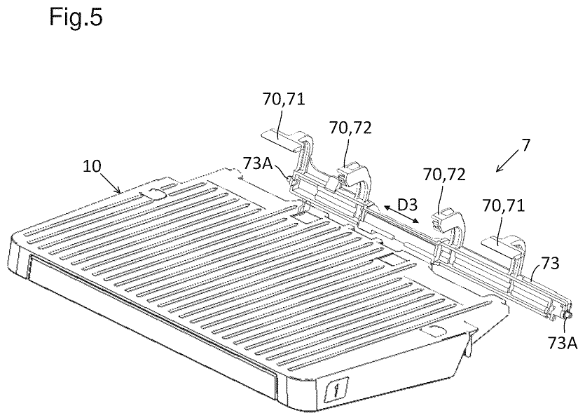

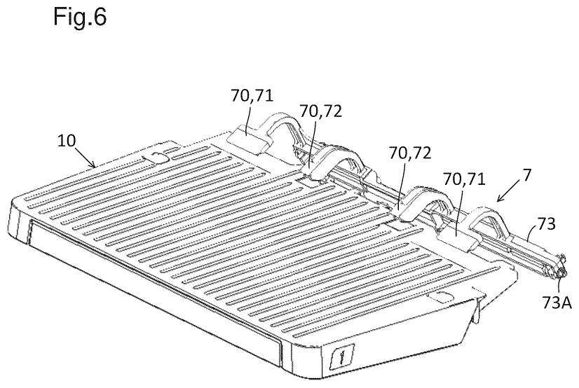

To prevent such inconveniences, the post-processing apparatus 100 includes a sheet pressing member 7 as shown in FIGS. 5 and 6. The sheet pressing member 7 presses the sheet S on the discharge tray 10 from above. Providing the sheet pressing member 7 allows it to press the warped part of the sheet S on the discharge tray 10 from above.

The sheet pressing member 7 is a resin-molded member. The sheet pressing member 7 has a plurality of pressing portions 70. It has, for example, four of the pressing portions 70. The plurality of pressing portions 70 are arrayed at an interval from each other along the width direction. The plurality of pressing portions 70 each press the sheet S on the discharge tray 10 from above.

Of the plurality of pressing portions 70, the two pressing portions 70 at the opposite ends along the width direction correspond to “first pressing portions.” In the following description, whenever distinction is needed among the plurality of pressing portions 70, the two pressing portions 70 at the opposite ends along the width direction are referred to as first pressing portions 71.

Of the plurality of pressing portions 70, the two pressing portions 70 other than the first pressing portions 71 (in other words, the two pressing portions 70 located between the two first pressing portion 71 along the width direction) correspond to “second pressing portions.” In the following description, whenever distinction is needed among the plurality of pressing portions 70, the two pressing portions 70 other than the first pressing portions 71 are referred to as second pressing portions 72.

The sheet pressing member 7 has a supporting portion 73. The supporting portion 73 has its longitudinal direction along the width direction. The plurality of pressing portions 70 are formed unitarily with the supporting portion 73. In addition, the supporting portion 73 unitarily has rotation shafts 73A at its opposite ends along the width direction. The rotation shafts 73A has its axial direction along the width direction. The rotation shafts 73A are supported so as to be rotatable with respect to the frame (not shown) of the post-processing apparatus 100.

As seen from the width direction, the plurality of pressing portions 70 each protrude radially outward of a circle about the rotation shafts 73A. Thus, as seen from the width direction, the plurality of pressing portions 70 can each move along a circumferential direction about the rotation shafts 73A. The plurality of pressing portions 70 are each substantially L-shaped as seen from the width direction.

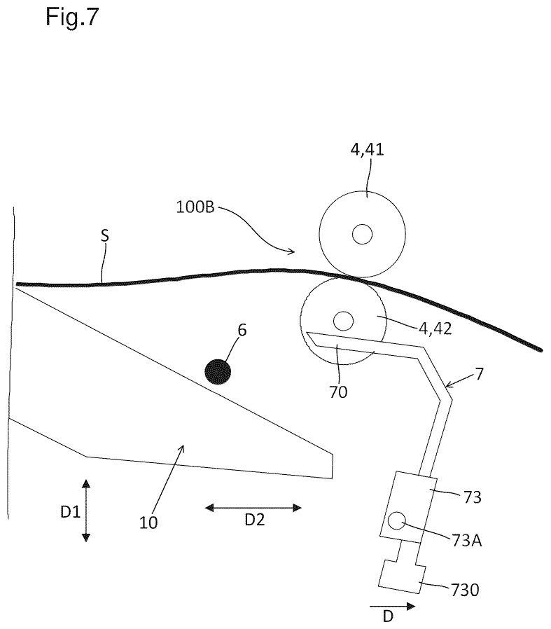

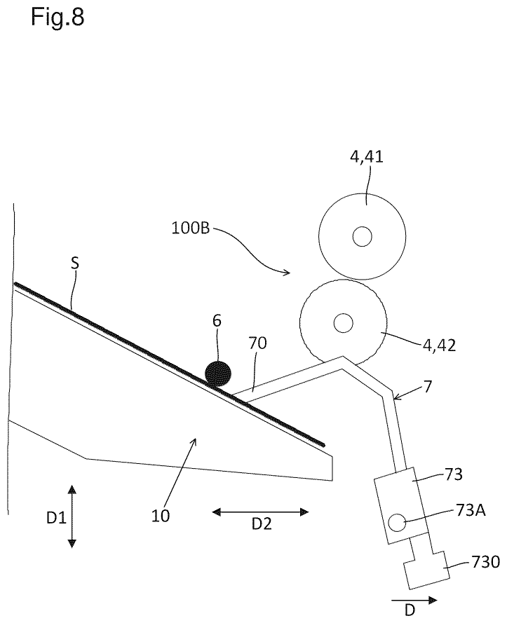

The positional relationship of the discharge tray 10 and the sheet pressing member 7 as seen from the width direction is shown in FIGS. 7 and 8. FIG. 7 shows a state where the sheet S on the discharge tray 10 is not pressed by the sheet pressing member 7 (hereinafter, referred to as a retracted state). FIG. 8 shows a state where the sheet S on the discharge tray 10 is pressed by the sheet pressing member 7 (hereinafter, referred to as a pressing state). Note that the state shown in FIG. 5 is the retracted state and the state shown in FIG. 6 is the pressing state.

For example, while not shown, as seen from the width direction, a coupling part 730 of the sheet pressing member 7, that is, a part of it opposite, with respect to the rotation shafts 73A, from where the plurality of pressing portions 70 are disposed, has a solenoid coupled to it. The plurality of pressing portions 70 move as the solenoid operates. The control portion 5 controls the solenoid to appropriately move the plurality of pressing portions 70.

From the released state shown in FIG. 7, as the solenoid pulls the coupling part 730 in the direction indicated by arrow D in the figure, the plurality of pressing portions 70 moves in a direction toward a stacking face (i.e., the face on which the sheet S is stacked) of the discharge tray 10. This brings the pressing state shown in FIG. 8.

From the pressing state shown in FIG. 8, as the solenoid ceases to pull the coupling part 730, the plurality of pressing portions 70 move in a direction apart from the stacking face of the discharge tray 10. This brings the released state shown in FIG. 7. For example, the sheet pressing member 7 is always urged, by an urging member, not shown, in a direction in which the plurality of pressing portions 70 move apart from the stacking face of the discharge tray 10. Thus, while the solenoid is not pulling the coupling part 730, the retracted state shown in FIG. 7 is reliably maintained.

In the retracted state, the plurality of pressing portions 70 are held in the retracted position. Held in the retracted position, the plurality of pressing portions 70 do not protrude into the sheet conveyance passage. That is, the retracted position is a position where the plurality of pressing portions 70 stays out of the sheet conveyance passage. Thus, in the retracted state, the conveyance of the sheet S (including the discharge of the sheet S) is not hindered by the plurality of pressing portions 70.

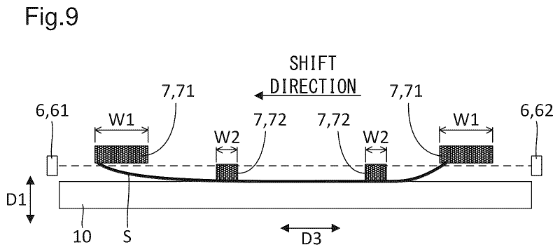

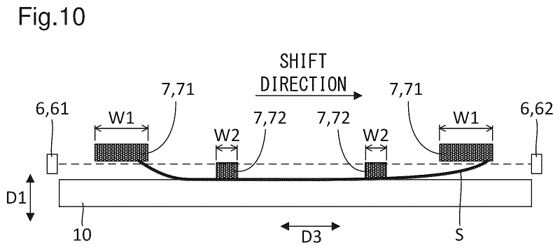

In addition, in the pressing state, the first pressing portions 71 lie in a higher position along the top-bottom direction than the second pressing portions 72 (see FIGS. 9 and 10). That is, the first pressing portions 71 press the sheet S on the discharge tray 10 from a position higher than the second pressing portions 72 does. The second pressing portions 72 nip the sheet S with the stacking face of the discharge tray 10.

When discharging the sheet S to the discharge tray 10, the control portion 5 holds the sheet pressing member 7 in the retracted state. In this state, the control portion 5 makes the discharge portion 4 discharge the sheet S to the discharge tray 10. When the sheet S has been discharged to the discharge tray 10, the control portion 5 brings the state of the sheet pressing member 7 into the pressing state. Then, when discharging the following sheet S to the discharge tray 10, the control portion 5 brings the state of the sheet pressing member 7 into the retracted state.

The sensing portion 6 is disposed, as seen from the width direction, at a position where its sensing region and the sheet pressing member 7 do not interfere with each other. Thus, the sheet pressing member 7 does not block the sensing region of the sensing portion 6 even when the sheet pressing member 7 is brought from the retracted state to the pressing state. In FIGS. 7 and 8, the sensing region of the sensing portion 6 is schematically represented by a solid black circle.

Shape of Pressing Member: The post-processing apparatus 100 can perform a sorting process. Through the sorting process, the position of the sheet S on the discharge tray 10 along the width direction is shifted copy by copy. Also, the sheets S conveyed into the post-processing apparatus 100 from the image forming apparatus 200 have varying sizes along the width direction. Thus, also depending on the size along the width direction of the sheet S conveyed into the post-processing apparatus 100, the position of the sheet S on the discharge tray 10 along the width direction changes.

To cope with that, in the embodiment, when the sheet S on the discharge tray 10 is pressed by the sheet pressing member 7 from above, regardless of the position and size of the sheet S on the discharge tray 10 along the width direction, one of the plurality of pressing portions 70 is arranged at a position opposite, along the top-bottom direction, an end part of the sheet S on the discharge tray 10 along the width direction. Thus, regardless of the position and size of the sheet S on the discharge tray 10 along the width direction, one of the pressing portions 70 reliably presses from above the warped part of the curled sheet S (i.e., the end parts of the sheet S along the width direction) on the discharge tray 10.

Here, in the embodiment, the first pressing portions 71 are larger in dimension along the width direction than the second pressing portions 72. Specifically, as shown in FIGS. 9 and 10, the dimension of the first pressing portions 71 along the width direction is W1, whereas the dimension of the second pressing portions 72 along the width direction is W2 (<W1).

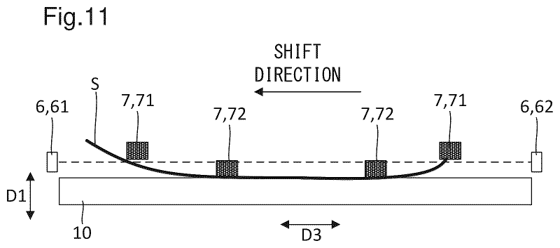

FIG. 9 shows a state where the discharging position of the sheet S on the discharge tray 10 is shifted in one direction (leftward in FIG. 9) along the width direction. FIG. 10 shows a state where the discharging position of the sheet S on the discharge tray 10 is shifted in the other direction (rightward in FIG. 10) along the width direction. Note that, in FIGS. 9 and 10, the sensing region of the sensing portion 6 (the optical path between the light emitting portion 61 and the light receiving portion 62 along the width direction) is indicated by a broken line. Also in FIG. 11, which will be referred to later, the sensing region of the sensing portion 6 is indicated by a broken line.

In the configuration where dimension W1 of the first pressing portions 71 along the width direction is greater than dimension W2 of the second pressing portions 72 along the width direction, as shown in FIG. 9, even if the discharging position of the sheet S on the discharge tray 10 is shifted in one direction along the width direction, the first pressing portion 71 in the one direction along the width direction can press from above the end part of the sheet S in the one direction along the width direction, and the first pressing portion 71 in the other direction along the width direction can press from above the end part of the sheet S in the other direction along the width direction. Likewise, as shown in FIG. 10, even if the discharging position of the sheet S on the discharge tray 10 is shifted in the other direction along the width direction, the first pressing portion 71 in the other direction along the width direction can press from above the end part of the sheet S in the other direction along the width direction, and the first pressing portion 71 in the one direction along the width direction can press from above the end part of the sheet S in the one direction along the width direction.

This helps, in the embodiment, improve the accuracy of position sensing, along the top-bottom direction, of the topmost sheet S on the discharge tray 10, so that it is possible to avoid too long a distance between the discharge tray 10 and the discharging port 100B in the top-bottom direction, that is, to avoid too long a falling distance of the sheet S from the discharging port 100B to the discharge tray 10. As a result, it is possible to prevent poor alignment of the sheet S on the discharge tray 10 and major damage to the sheet S.

In a configuration with the first pressing portions 71 not enlarged along the width direction, that is, in a configuration as shown in FIG. 11, if the discharging position of the sheet S on the discharge tray 10 is shifted along the width direction (leftward in FIG. 11), an end part of the sheet S along the width direction may not be pressed from above. In this case, if the sheet S on the discharge tray 10 is severely curled, the position along the top-bottom direction of the topmost sheet S on the discharge tray 10 is sensed with insufficient pressing on the warped part of the sheet S. This results in poor accuracy of position sensing.

Note that, if the image forming apparatus 200 is an inkjet recording apparatus, the sheet S is more likely to curl severely. Thus, when the image forming apparatus 200 is an inkjet recording apparatus, it is preferable to reliably press, on the discharge tray 10, an end part of the sheet S along the width direction from above.

As a modified example, while not shown, the number of pressing portions 70 can be increased such that one of the pressing portions 70 is arranged at a position opposite, along the top-bottom direction, an end part of the sheet S on the discharge tray 10 along the width direction.

The embodiment disclosed herein should be understood to be in every aspect illustrative and not restrictive. The scope of the present disclosure is defined not by the description of the embodiment given above but by the appended claims and encompasses any modifications within a scope equivalent in significance to those claims.

For example, while the above embodiment deals with an example where the present disclosure is applied to a post-processing apparatus including a stapler as a post-processing portion, this is not meant as any limitation: the present disclosure is applicable to post-processing apparatuses including any post-processing portion other than a stapler. The present disclosure can also be applied to sheet discharge apparatuses provided with no post-processing function.

What is claimed is:

1. A sheet discharge apparatus comprising:
a discharge tray to which a sheet is discharged; and
a plurality of pressing portions arrayed at an interval from each other along a width direction orthogonal to a discharge direction of the sheet, the plurality of pressing portions each pressing the sheet on the discharge tray from above,
wherein
when the sheet on the discharge tray is pressed, regardless of a position and a size of the sheet on the discharge tray along the width direction, one of the plurality of pressing portions is arranged at a position opposite, along a top-bottom direction, an end part of the sheet on the discharge tray along the width direction.

2. The sheet discharge apparatus according to claim 1, wherein
of the plurality of pressing portions, first pressing portions at opposite ends along the width direction are larger in dimension along the width direction than second pressing portions other than the first pressing portions.

3. The sheet discharge apparatus according to claim 1, further comprising:
a processing tray on which the sheet is stacked when a sorting process is performed in which the position of the sheet on the discharge tray along the width direction is shifted copy by copy;
a pair of cursors reciprocatable along the width direction on the processing tray, the pair of cursors lying on opposite sides of the sheet on the processing tray along the width direction; and
a discharge portion discharging the sheet on the processing tray to the discharge tray,
wherein
in the sorting process,
the pair of cursors move along the width direction with the sheet on the processing tray held therebetween along the width direction so as to shift the sheet on the processing tray along the width direction, and
the discharge portion discharges to the discharge tray the sheet on the processing tray thus shifted along the width direction.

4. The sheet discharge apparatus according to claim 1, wherein
the discharge tray is reciprocatable along the top-bottom direction,
the sheet discharge apparatus further comprises:
a sensing portion sensing a position of a topmost one of the sheet on the discharge tray along the top-bottom direction; and
a control portion controlling a position of the discharge tray along the top-bottom direction,
the sensing portion includes an optical sensor of a transmission type including a light emitting portion and a light receiving portion disposed so as to face each other along the width direction across the sheet on the discharge tray, the sensing portion changing an output thereof depending on whether light emitted from the light emitting portion to the light receiving portion is intercepted by the sheet on the discharge tray, and
based on the output of the sensing portion, the control portion controls the position of the discharge tray along the top-bottom direction.

5. The sheet discharge apparatus according to claim 1, further comprising
a post-processing portion that performs post-processing on the sheet.

6. An image forming system comprising:
the sheet discharge apparatus according to claim 1; and
an image forming apparatus forming an image on the sheet,
wherein
the sheet discharge apparatus discharges the sheet conveyed thereto from the image forming apparatus to the discharge tray.

7. The image forming system according to claim 6, wherein
the image forming apparatus is an inkjet recording apparatus and ejects ink onto the sheet to form the image on the sheet.
